(19) United States
(12) Patent Application Publication
(10) Pub. No.: US 2026/0166728 A1
(43) Pub. Date: Jun. 18, 2026

(54) Telescopic Electric Cylinder Based On high-precision Stroke Control And Its Operating Method

(71) Applicant: Shanghai Dizi Precision Machinery Co.,Ltd., Shanghai (CN)

(72) Inventor: Yijie CAO, Shanghai (CN)

(21) Appl. No.: 19/415,569

(22) Filed: Dec. 10, 2025

(30) Foreign Application Priority Data
Dec. 13, 2024 (CN) 202411834606.5

(51) Int. Cl. B25J 9/16; B25J 9/12

(52) U.S. Cl. CPC B25J 9/1638; B25J 9/123; B25J 9/1653; B25J 9/1661

(57) ABSTRACT

The present invention relates to the technical field of telescopic cylinders, specifically to a telescopic cylinder based on high-precision stroke control and its operating method. The system includes a telescopic cylinder body, which comprises a housing, a rear sealing cover, a front sealing cover, a frameless motor, a front connector, a rear connector, a planetary nut, a planetary screw, a mounting base, a pressure sensor, two angular contact bearings, a bearing pressure plate, a deep groove ball bearing, a linear shaft nut, a capping, and an encoder. Openings are provided at both the front and rear sides of the housing; the rear sealing cover is installed at the rear opening of the housing, while the front sealing cover is installed at the front opening.

### CROSS-REFERENCE TO RELATED APPLICATIONS

This application claims priority to Chinese Patent Application No. 202411834606.5, filed on Dec. 13, 2024, the content of which is incorporated herein by reference in its entirety.

### TECHNICAL FIELD

The invention belongs to the technical field of telescopic electric cylinders, and specifically relates to a telescopic electric cylinder based on high-precision stroke control and its operating method.

### BACKGROUND

The electric cylinder is a modular product that integrates a servo motor with a screw lever. It can convert the rotary motion of the servo motor into linear motion, while retaining the advantages of the servo motor such as precise speed control, accurate rotation control, and accurate torque control, thereby enabling precise velocity, position, and thrust control. At present, telescopic electric cylinders are mostly used in robotic arms to control their extension and retraction. However, when the robotic arm moves while gripping an object, the lifespan of the telescopic electric cylinder is affected by the weight of the object. The instability in the rotation of the frameless motor, along with excessive or insufficient speed, may cause the object to be dragged by inertia into the structure of the telescopic electric cylinder. This leads to wear and tear of the internal structure and a reduced service life. Therefore, optimizing the operation of the frameless motor has become an urgent problem to be solved in the field.

### SUMMARY

The purpose of the present invention is to provide a telescopic electric cylinder based on high-precision stroke control and its operating method, in order to solve the problems proposed in the background art described above.

To solve the above technical problems, the present application provides the following technical solution: a telescopic electric cylinder based on high-precision stroke control and its operating method. The telescopic electric cylinder comprises a cylinder body, wherein the telescopic cylinder body comprises a housing, a rear sealing cover, a front sealing cover, a frameless motor, a front connector, a rear connector, a planetary nut, a planetary screw, a mounting base, a pressure sensor, two angular contact bearings, a bearing pressure plate, a deep groove ball bearing, a linear shaft nut, a capping, and an encoder, wherein both a front side and a rear side of the housing are provided at least one opening; wherein the housing is provided with an opening on front side of the housing and rear side of the housing, the rear sealing cap is installed at the opening of the rear side of the housing, and the front end cap is installed at the opening of the front side of the housing; wherein the frameless motor is arranged inside the housing, wherein the frameless motor comprises a stator connected to an inner wall of the housing, wherein the planetary nut is positioned inside the housing and is connected to a rotor of the frameless motor, rotating along with the rotor to transmit power, wherein a rear end of the planetary screw meshes with the planetary nut, and a front end passes of the planetary screw passes through the front sealing cover and extends outward; wherein under an action of the planetary nut, the planetary screw performs linear motion, wherein the mounting base is connected to a rear end of the planetary nut, and the encoder is connected to the mounting base, wherein the front connector is connected to a front end of the planetary screw, and the rear connector is connected to the rear sealing cover, wherein the front connector and rear connector are used for connecting to external equipment, wherein spherical bearings are installed on both the front connector and the rear connector, wherein the pressure sensor is installed between the rear sealing cover and the rear connector and is used to detect the pressure experienced by the telescopic cylinder during operation for allowing adjustment an operational state of telescopic cylinder, wherein the two angular contact bearings are positioned between the housing and the planetary nut, and the bearing pressure plate secures the two angular contact bearings in a place which is between the housing and the planetary nut, wherein the deep groove ball bearing is positioned between the planetary nut and the rear sealing cover, wherein the linear shaft nut is arranged between the front sealing cover and the planetary screw, and the capping secures the linear shaft nut between the front sealing cover and the planetary screw, wherein a high-precision stroke control system is encoded into the encoder, wherein the telescopic cylinder is designed to be mounted on a robotic arm, providing extension and retraction through an action of the telescopic cylinder, and the robotic arm is used for object gripping.

Preferably, the high-precision stroke control system comprises a parameter identification module, a stroke control module, and a deceleration control module; wherein the parameter identification module is electrically connected to the deceleration control module; both the stroke control module and the deceleration control module are electrically connected to a frameless motor; wherein the parameter identification module is disposed at a gripping portion of the robotic arm and is configured to identify various parameters of an object grasped by the robotic arm; wherein the deceleration control module is configured to control the frameless motor to decelerate based on the various parameters of the object gripped by the robotic arm and to regulate speed reduction rate during deceleration of the frameless motor; wherein the stroke control module is configured to automatically control a number of revolutions of the frameless motor according to operation requirements, thereby controlling a stroke of the telescopic electric cylinder.

Preferably, the parameter identification module comprises a weight unit, a height unit, and a distance measurement unit; wherein the weight unit, the height unit, and the distance measurement unit are electrically connected to one another; wherein the weight unit is used to identify a weight of the object being grabbed by the robotic arm, the height unit is used to identify a final height at which the object is lifted after being grabbed, and the distance measuring unit is used to measure an extended distance of the telescopic electric cylinder.

Preferably, The operation method for a telescopic electric cylinder based on high-precision stroke control according to claim 3, wherein the operation steps of the high-precision stroke control system include: step S1, the robotic arm grips the object, and the frameless motor controls the extension and retraction of the telescopic electric cylinder through the interaction between the planetary lead screw and the planetary nut for controlling the extension and retraction movement of the robotic arm after grabbing the object, allowing movement of the object; step S2, the weight unit identifies the weight of the object gripped by the robotic arm, and based on the object's weight, the inertia experienced by the object during movement is measured, wherein the deceleration control module then controls the deceleration of the frameless motor and adjusts the first speed reduction rate during deceleration; step S3, the height unit identifies the final height to which the object is lifted after being gripped, and based on the object's height, the second speed reduction rate of the frameless motor during deceleration is further controlled. If the distance measuring unit detects a high extension distance of the object, the system proceeds to step S4; otherwise, it moves to step S6;step S4, after the object's extension distance increases, the planetary lead screw in the telescopic electric cylinder experiences an increased downward force, which causes a tighter fit between the planetary lead screw and the planetary nut, wherein at this point, the deceleration control of the frameless motor is adjusted to the third speed reduction rate; step S5, the inertia of the object which is moving is influenced by the tightness of the fit between the planetary lead screw and the planetary nut, wherein the inertia data is then adjusted, and the fourth speed reduction rate of the frameless motor during deceleration is calculated; step S6, afterward, the robotic arm lowers the object and the frameless motor reverses to reset, preparing for the next operation.

Preferably, the first speed deceleration rate in the step S2 is defined as follows:

$$I = \frac{G}{{G}_{max}} * {I}_{max} , {V}_{1} = \frac{{I}_{min}}{I} * {V}_{max} ,$$

wherein G is the weight of the object wherein Gₘₐₓ is the maximum weight of the object that the robotic arm can handle, wherein I is the inertia of the object during the object movement, wherein Iₘₐₓ is the maximum inertia during the object movement, wherein Iₘᵢₙ is the minimum inertia during the object movement, wherein Vₘₐₓ is the maximum speed reduction rate of the frameless motor, wherein V₁ is the first speed reduction rate of the frameless motor.

Preferably, the second deceleration rate in step S3 is defined as follows:

$${I}_{1} = \frac{H}{{H}_{max}} * {I}_{max} ,$$

wherein H is the height at which the object is located, wherein Hₘₐₓ is the maximum height at which the object can be gripped, wherein I₁ represents the influence of the object's height on inertia; wherein,

$$I = \frac{G}{{G}_{max}} * {I}_{max} - {I}_{1} ,$$

wherein the higher position of the object, the greater the downward force of the object experiences, which affects the inertia and reduces the inertia of the object during deceleration, wherein the second deceleration rate of the frameless motor is: V₂=V₁−

$$[ {I}_{min} / ( \frac{G}{{G}_{max}} * {I}_{max} - {I}_{1} ) ] * {V}_{max} .$$

Preferably, the third deceleration rate in step S4 is defined as follows: when L>L_{mid}, wherein L is the object's extension distance, wherein L_{mid} is the normal extension distance of the object:

$$R = \frac{L}{{L}_{max}} * {R}_{max} ,$$

wherein Lₘₐₓ is the maximum extension distance of the object, R is the fit tightness between the planetary screw and the planetary nut, wherein Rₘₐₓ is the maximum fit tightness between the planetary screw and the planetary nut, wherein the influence of this fit tightness on the deceleration rate of the frameless motor is:

$${V}_{t i g h t} = \frac{{R}_{min}}{R} * V {1}_{max} ,$$

wherein V_{tight} is the influence of the planetary screw and the planetary nut fit tightness on the deceleration rate of the frameless motor, V1ₘₐₓ is the maximum influence between the planetary screw and the planetary nut that can have on the deceleration rate, Rₘᵢₙ is the minimum fit tightness between the planetary screw and the planetary nut; wherein the third deceleration rate is:

$${V}_{3} = {V}_{1} - [ \frac{{I}_{min}}{( \frac{G}{{G}_{max}} * {I}_{max} - {I}_{1} )} ] * {V}_{max} - {V}_{tight} ;$$

wherein when L≤L_{mid}, then V₃=V₂.

Preferably, the fourth deceleration reset in Step S5 is defined as follows:

$${I}_{2} = \frac{{R}_{min}}{R} * I {2}_{max} , I = \frac{G}{{G}_{max}} * {I}_{max} - {I}_{1} - {I}_{2} ,$$

wherein I₂ is the influence of the tightness between the planetary screw and the planetary nut on the inertia of the object during movement, I2ₘₐₓ is the maximum influence of the tightness between the planetary screw and the planetary nut on movement inertia of the object;
wherein the fourth deceleration rate is then:

$${V}_{4} = {V}_{1} - [ \frac{{I}_{min}}{( \frac{G}{{G}_{max}} * {I}_{max} - {I}_{1} )} ] * {V}_{max} + [ {I}_{min} / ( \frac{G}{{G}_{max}} * {I}_{max} - {I}_{1} - {I}_{2} ) ] * {V}_{max} ;$$

wherein when L≤L_{mid}, then V₄=V₂.

Compared with the prior art, the beneficial effects achieved by the present invention are as follows: The high-precision stroke control system used in the present invention, on one hand, reduces the speed reduction amplitude of the frameless motor when the object is heavy, thus avoiding excessive inertia that could lead to excessive force between the planetary screw 600 and planetary nut 500, which would affect the tightness between them. This prevents loosening caused by excessive force and protects the telescopic electric cylinder. On the other hand, when the object is lighter, the speed reduction amplitude of the frameless motor can be increased to ensure the smoothness of the object's movement and reduce the motor speed more quickly, thus improving work efficiency.

For objects at higher positions, the downward force acting on them increases their inertia, which reduces the inertia during deceleration. Conversely, when the inertia increases, the system further refines the inertia data to better control the speed reduction amplitude of the frameless motor during deceleration. This results in better cushioning, reduces structural wear, and increases the service life of the telescopic electric cylinder.

When the telescopic electric cylinder extends longer, the mechanical arm exerts more downward force on the object, making the planetary screw and planetary nut fit more tightly. In this case, the speed reduction amplitude is further decreased, allowing the frameless motor to decelerate more slowly. This reduces wear between the planetary screw and planetary nut, thereby protecting the structure and extending the service life of the system.

### BRIEF DESCRIPTION OF THE DRAWINGS

The drawings are provided to further understand the present invention and form part of the specification. They are used in conjunction with the embodiments of the present invention to explain the invention and do not limit it. In the drawings:

FIG. 1 is a schematic diagram of the overall structure of the Telescopic electric cylinder based on high-precision stroke control of the first embodiment.

FIG. 2 is a schematic diagram of the overall structure of the Telescopic electric cylinder based on high-precision stroke control of the second embodiment.

FIG. 3 is a schematic diagram of the module connection relationship of the high-precision stroke control system of the present invention.

### DETAILED DESCRIPTION OF THE EMBODIMENTS

The following is a further detailed, non-limiting description of the technical solutions of the present invention with reference to the preferred embodiments and the accompanying drawings. It should be understood that the described embodiments are merely illustrative and not exhaustive. Various other embodiments and modifications may be devised by those skilled in the art without departing from the spirit and scope of the invention, and such embodiments are intended to be within the scope of the present invention.

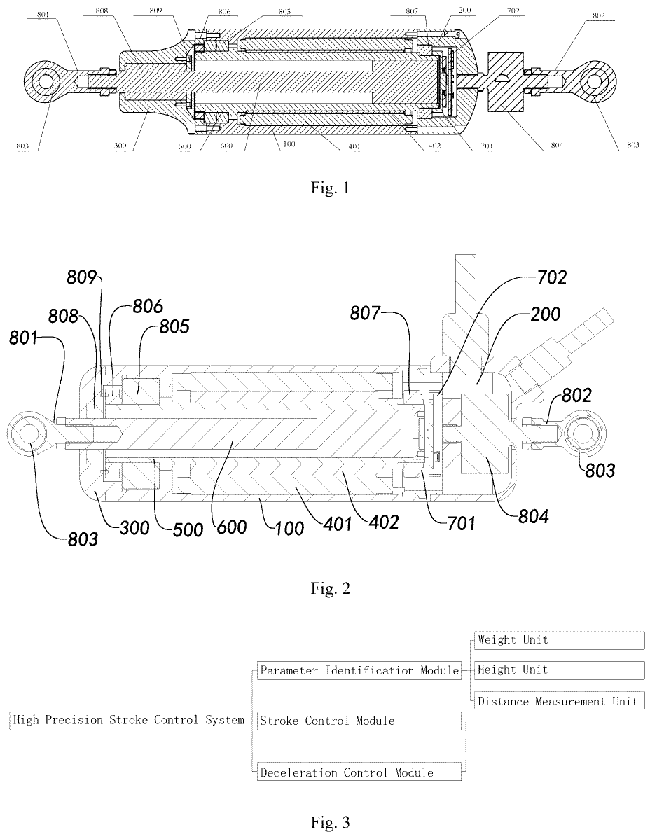

Referring to FIGS. 1-3, the present disclosure provides a technical solution directed to a telescopic electric cylinder with high-precision stroke control and its operating method. The telescopic electric cylinder comprises a telescopic electric cylinder body, which includes a housing 100, a rear sealing cap 200, a front sealing cap 300, a frameless motor, a front connector 801, a rear connector 802, a planetary nut 500, a planetary screw 600, a mounting base 701, a pressure sensor 804, two angular contact bearings 805, a bearing retainer 806, a deep groove ball bearing 807, a linear shaft nut 808, a capping 809, and an encoder 702. The housing 100 is provided with an opening on both its front side and its rear side. The rear sealing cap 200 is installed at the rear side opening of the housing 100, and the front end cap 300 is installed at the front side opening of the housing 100.

The frameless motor is installed inside the housing 100, wherein the frameless motor comprises a stator 401 connected to the inner wall of the housing 100. The planetary nut 500 is positioned inside the housing 100 and is connected to a rotor 402 of the frameless motor, rotating along with the rotor 402 to transmit power. The rear end of the planetary lead screw 600 meshes with the planetary nut 500, while the front end of the planetary lead screw 600 passes through the front sealing cover 300 and extends outside. Under the action of the planetary nut 500, the planetary lead screw 600 performs linear motion. The mounting base 701 is connected to the rear end of the planetary nut 500, and the encoder 702 is connected to the mounting base 701. The front connector 801 is connected to the front end of the planetary lead screw 600, and the rear connector 802 is connected to the rear sealing cover 200. The front and rear connectors 801 and 802 are used to connect with external devices. Both the front connectors 801 and the rear connector 802 are provided with spherical bearings 803. The pressure sensor 804 is connected between the rear sealing cover 200 and the rear connector 802 and is used to detect the pressure exerted during the operation of the telescopic electric cylinder, thereby adjusting its operating state. The two angular contact bearings 805 are installed between the housing 100 and the planetary nut 500. The bearing pressure plate 806 secures the two angular contact bearings 805 between the housing 100 and the planetary nut 500. The deep groove ball bearing 807 is arranged between the planetary nut 500 and the rear sealing cover 200. The linear shaft nut 808 is positioned between the front sealing cover 300 and the planetary lead screw 600. The capping 809 secures the linear shaft nut 808 between the front sealing cover 300 and the planetary lead screw 600.

A high-precision stroke control system is encoded into the encoder 702. The telescopic electric cylinder is designed to be mounted on a robotic arm and drives the arm to extend and retract through its telescopic motion. The robotic arm is used for gripping objects.

By driving the rotor 402 through the stator 401 of the frameless motor, the planetary nut 500 is rotated, which in turn causes the planetary screw 600 to move linearly under the action of the planetary nut 500. The overall internal structure is not only simple, intuitive, compact, and orderly, but also greatly facilitates user disassembly and maintenance. This electric cylinder is compact and exquisitely designed, occupying minimal space, making it especially suitable for use in confined or space-constrained environments. Its optimized design ensures a streamlined and efficient structure without compromising functionality or stability, providing users with a convenient and practical solution. Additionally, the high-precision stroke control system enables precise control over the stroke of the telescopic electric cylinder, thereby enhancing the accuracy of motion control for external devices.

The high-precision stroke control system includes a parameter identification module, a stroke control module, and a deceleration control module.

The parameter identification module is electrically connected to the deceleration control module, and both the stroke control module and deceleration control module are electrically connected to the frameless motor. The parameter identification module is located at the gripping position of the robotic arm and is used to identify various parameters of the object being gripped by the robotic arm. The deceleration control module is used to control the deceleration of the frameless motor based on the parameters of the object being gripped, and it controls the speed reduction rate during deceleration. The stroke control module is used to automatically control the number of revolutions of the frameless motor according to operational requirements, thereby controlling the stroke of the telescopic electric cylinder.

The parameter identification module includes a weight unit, a height unit, and a distance measuring unit, which are electrically connected to each other. The weight unit is used to identify the weight of the object being grabbed by the robotic arm, the height unit is used to identify the final height at which the object is lifted after being grabbed, and the distance measuring unit is used to measure the extended distance of the telescopic electric cylinder.

The operating method of the high-precision stroke control system include:
Step S1, the robotic arm grips the object, and the frameless motor controls the extension and retraction of the telescopic electric cylinder through the interaction between the planetary lead screw 600 and the planetary nut 500 for controlling the extension and retraction movement of the robotic arm after grabbing the object, allowing movement of the object.
Step S2, the weight unit identifies the weight of the object gripped by the robotic arm, and based on the object's weight, the inertia experienced by the object during movement is measured. The deceleration control module then controls the deceleration of the frameless motor and adjusts the first speed reduction rate during deceleration.
Step S3, the height unit identifies the final height to which the object is lifted after being gripped, and based on the object's height, the second speed reduction rate of the frameless motor during deceleration is further controlled. If the distance measuring unit detects a high extension distance of the object, the system proceeds to step S4; otherwise, it moves to step S6.
Step S4, after the object's extension distance increases, the planetary lead screw 600 in the telescopic electric cylinder experiences an increased downward force, which causes a tighter fit between the planetary lead screw 600 and the planetary nut 500. At this point, the deceleration control of the frameless motor is adjusted to the third speed reduction rate.
Step S5, the inertia of the object which is moving is influenced by the tightness of the fit between the planetary lead screw 600 and the planetary nut 500. The inertia data is then adjusted, and the fourth speed reduction rate of the frameless motor during deceleration is calculated.
Step S6, afterward, the robotic arm lowers the object and the frameless motor reverses to reset, preparing for the next operation.

The first speed reduction rate in Step S2 is defined as follows:

$$I = \frac{G}{{G}_{max}} * {I}_{max} , {V}_{1} = \frac{{I}_{max}}{I} * {V}_{max} ,$$

wherein G is the weight of the object, wherein Gₘₐₓ is the maximum weight of the object that the robotic arm can handle, wherein I is the inertia of the object during the object movement, wherein Iₘₐₓ is the maximum inertia during the object movement, wherein Iₘᵢₙ is the minimum inertia during the object movement, wherein Vₘₐₓ is the maximum speed reduction rate of the frameless motor, wherein V₁ is the first speed reduction rate of the frameless motor.

In other words, the heavier the object, the greater the inertia, which leads to a smaller speed reduction rate for the frameless motor during deceleration.

On one hand, for heavier object, the speed reduction rate of the frameless motor is reduced, thus avoiding excessive force that could affect the tightness between the planetary lead screw 600 and the planetary nut 500 due to high inertia, preventing loosening of the planetary lead screw 600 and the planetary nut 500, protecting the telescopic electric cylinder. On the other hand, for lighter object, the speed reduction rate of the frameless motor can be increased, ensuring smoother movement of the object and allowing the motor to decelerate more quickly, which improves work efficiency.

The second deceleration rate in Step S3 is defined as follows:

$${I}_{1} = \frac{H}{{H}_{max}} * {I}_{max} ,$$

wherein H is the height at which the object is located, wherein Hₘₐₓ is the maximum height at which the object can be gripped, wherein I₁ represents the influence of the object's height on inertia.

Thus,

$$I = \frac{G}{{G}_{max}} * {I}_{max} - {I}_{1} ,$$

The higher the object's position, the greater the downward force of the object experiences, which affects the inertia and reduces the inertia of the object during deceleration. The second deceleration rate of the frameless motor is:

$${V}_{2} = {V}_{1} - [ {I}_{min} / ( \frac{G}{{G}_{max}} * {I}_{max} - {I}_{1} ) ] * {V}_{max} .$$

For objects located at higher positions, the downward acting force on their inertia is greater, which reduces the inertia during deceleration. Conversely, for lower positions, the inertia increases. This allows for more precise calculation of the inertia data the object is subjected to, enabling more accurate control of the speed reduction gradient of the frameless motor during deceleration. As a result, a better buffering effect is achieved, further reducing wear between structural components and extending the service life of the telescopic electric cylinder.

The third deceleration rate in Step S4 is defined as follows:

When L>L_{mid}, wherein L is the object's extension distance, wherein L_{mid} is the normal extension distance of the object:

$$R = \frac{L}{{L}_{max}} * {R}_{max} ,$$

wherein Lₘₐₓ is the maximum extension distance of the object, R is the fit tightness between the planetary screw 600 and the planetary nut 500, wherein Rₘₐₓ is the maximum fit tightness between the planetary screw 600 and the planetary nut 500. The influence of this fit tightness on the deceleration rate of the frameless motor is:

$${V}_{t i g h t} = \frac{{R}_{min}}{R} * V {1}_{max} ,$$

wherein V_{tight} is the influence of the planetary screw 600 and the planetary nut 500 fit tightness on the deceleration rate of the frameless motor, V1ₘₐₓ is the maximum influence between the planetary screw 600 and the planetary nut 500 that can have on the deceleration rate, Rₘᵢₙ is the minimum fit tightness between the planetary screw 600 and the planetary nut 500.

Therefore, the third deceleration rate is:

$${V}_{3} = {V}_{1} - [ \frac{{I}_{min}}{( \frac{G}{{G}_{max}} * {I}_{max} - {I}_{1} )} ] * {V}_{max} - {V}_{tight} ;$$

When L≤L_{mid}, then V₃=V₂.

When the telescopic electric cylinder is extended to a longer length, the robotic arm experiences a greater downward force while gripping the object, resulting in tighter fit between the planetary screw 600 and the planetary nut 500. At this point, the speed reduction rate is further decreased accordingly, causing the frameless motor to decelerate more gradually. This helps reduce wear between the planetary screw 600 and the planetary nut 500, thereby protecting the structure and further extending its service life.

The fourth deceleration reset in Step S5 is defined as follows:

$${I}_{2} = \frac{{R}_{min}}{R} - I {2}_{max} , I = \frac{G}{{G}_{max}} * {I}_{max} - {I}_{1} - {I}_{2} .$$

wherein I₂ is the influence of the tightness between the planetary screw 600 and the planetary nut 500 on the inertia of the object during movement, I2ₘₐₓ is the maximum influence of the tightness between the planetary screw 600 and the planetary nut 500 on the object's movement inertia.

The fourth deceleration rate is then:

$${V}_{4} = {V}_{1} - [ \frac{{I}_{min}}{( \frac{G}{{G}_{max}} * {I}_{max} - {I}_{1} )} ] * {V}_{max} + [ {I}_{min} / ( \frac{G}{{G}_{max}} * {I}_{max} - {I}_{1} - {I}_{2} ) ] * {V}_{max} ;$$

When L≤L_{mid}, then V₄=V₂.

After the tightness between the planetary screw 600 and the planetary nut 500 increases, the movement of the object slows down. Accordingly, the speed reduction gradient of the frameless motor can be slightly increased, which helps to relatively enhance the object's movement speed and improve work efficiency

In the description of the present invention, it should be understood that terms such as “upper,” “lower,” “front,” “rear,” “left,” “right,” and the like indicate positional or directional relationships based on those shown in the accompanying drawings. They are used solely for the purpose of describing the invention more clearly and are not intended to indicate or imply that the referenced devices or elements must have a particular orientation or be constructed and operated in a particular orientation. Therefore, these terms should not be construed as limiting the scope of the invention.

Finally, it should be noted that the above embodiments are provided solely to illustrate the technical solutions of the present invention and are not intended to limit them. Although the present invention has been described in detail with reference to the foregoing embodiments, those of ordinary skill in the art should understand that modifications may still be made to the technical solutions described in the above embodiments, or technical features therein may be substituted with equivalents, without departing from the essence and scope of the technical solutions of the embodiments of the present invention.

What is claimed is:

1. A telescopic cylinder based on high-precision stroke control, which comprises a telescopic cylinder body, wherein the telescopic cylinder body comprises a housing, a rear sealing cover, a front sealing cover, a frameless motor, a front connector, a rear connector, a planetary nut, a planetary screw, a mounting base, a pressure sensor, two angular contact bearings, a bearing pressure plate, a deep groove ball bearing, a linear shaft nut, a capping, and an encoder, wherein both a front side and a rear side of the housing are provided at least one opening; wherein the housing is provided with an opening on front side of the housing and rear side of the housing, the rear sealing cap is installed at the opening of the rear side of the housing, and the front end cap is installed at the opening of the front side of the housing;
wherein the frameless motor is arranged inside the housing, wherein the frameless motor comprises a stator connected to an inner wall of the housing, wherein the planetary nut is positioned inside the housing and is connected to a rotor of the frameless motor, rotating along with the rotor to transmit power, wherein a rear end of the planetary screw meshes with the planetary nut, and a front end passes of the planetary screw passes through the front sealing cover and extends outward; wherein under an action of the planetary nut, the planetary screw performs linear motion, wherein the mounting base is connected to a rear end of the planetary nut, and the encoder is connected to the mounting base, wherein the front connector is connected to a front end of the planetary screw, and the rear connector is connected to the rear sealing cover, wherein the front connector and rear connector are used for connecting to external equipment, wherein spherical bearings are installed on both the front connector and the rear connector, wherein the pressure sensor is installed between the rear sealing cover and the rear connector and is used to detect the pressure experienced by the telescopic cylinder during operation for allowing adjustment an operational state of telescopic cylinder, wherein the two angular contact bearings are positioned between the housing and the planetary nut, and the bearing pressure plate secures the two angular contact bearings in a place which is between the housing and the planetary nut, wherein the deep groove ball bearing is positioned between the planetary nut and the rear sealing cover, wherein the linear shaft nut is arranged between the front sealing cover and the planetary screw, and the capping secures the linear shaft nut between the front sealing cover and the planetary screw, wherein a high-precision stroke control system is encoded into the encoder, wherein the telescopic cylinder is designed to be mounted on a robotic arm, providing extension and retraction through an action of the telescopic cylinder, and the robotic arm is used for object gripping.

2. An operation method of a telescopic electric cylinder based on high-precision stroke control, wherein the telescopic electric cylinder comprises a telescopic cylinder body, wherein the telescopic cylinder body comprises a housing, a rear sealing cover, a front sealing cover, a frameless motor, a front connector, a rear connector, a planetary nut, a planetary screw, a mounting base, a pressure sensor, two angular contact bearings, a bearing pressure plate, a deep groove ball bearing, a linear shaft nut, a capping, and an encoder, wherein both a front side and a rear side of the housing are provided at least one opening; wherein the housing is provided with an opening on front side of the housing and rear side of the housing, the rear sealing cap is installed at the opening of the rear side of the housing, and the front end cap is installed at the opening of the front side of the housing;
wherein the frameless motor is arranged inside the housing, wherein the frameless motor comprises a stator connected to an inner wall of the housing, wherein the planetary nut is positioned inside the housing and is connected to a rotor of the frameless motor, rotating along with the rotor to transmit power, wherein a rear end of the planetary screw meshes with the planetary nut, and a front end passes of the planetary screw passes through the front sealing cover and extends outward; wherein under an action of the planetary nut, the planetary screw performs linear motion, wherein the mounting base is connected to a rear end of the planetary nut, and the encoder is connected to the mounting base, wherein the front connector is connected to a front end of the planetary screw, and the rear connector is connected to the rear sealing cover, wherein the front connector and rear connector are used for connecting to external equipment, wherein spherical bearings are installed on both the front connector and the rear connector, wherein the pressure sensor is installed between the rear sealing cover and the rear connector and is used to detect the pressure experienced by the telescopic cylinder during operation for allowing adjustment an operational state of telescopic cylinder, wherein the two angular contact bearings are positioned between the housing and the planetary nut, and the bearing pressure plate secures the two angular contact bearings in a place which is between the housing and the planetary nut, wherein the deep groove ball bearing is positioned between the planetary nut and the rear sealing cover, wherein the linear shaft nut is arranged between the front sealing cover and the planetary screw, and the capping secures the linear shaft nut between the front sealing cover and the planetary screw, wherein a high-precision stroke control system is encoded into the encoder, wherein the telescopic cylinder is designed to be mounted on a robotic arm, providing extension and retraction through an action of the telescopic cylinder, and the robotic arm is used for object gripping;
wherein the high-precision stroke control system comprises a parameter identification module, a stroke control module, and a deceleration control module;
wherein the parameter identification module is electrically connected to the deceleration control module; both the stroke control module and the deceleration control module are electrically connected to a frameless motor;
wherein the parameter identification module is disposed at a gripping portion of the robotic arm and is configured to identify various parameters of an object grasped by the robotic arm;
wherein the deceleration control module is configured to control the frameless motor to decelerate based on the various parameters of the object gripped by the robotic arm and to regulate speed reduction rate during deceleration of the frameless motor;
wherein the stroke control module is configured to automatically control a number of revolutions of the frameless motor according to operation requirements, thereby controlling a stroke of the telescopic electric cylinder.

3. The operation method for a telescopic electric cylinder based on high-precision stroke control according to claim 2, wherein the parameter identification module comprises a weight unit, a height unit, and a distance measurement unit; wherein the weight unit, the height unit, and the distance measurement unit are electrically connected to one another; wherein the weight unit is used to identify a weight of the object being grabbed by the robotic arm, the height unit is used to identify a final height at which the object is lifted after being grabbed, and the distance measuring unit is used to measure an extended distance of the telescopic electric cylinder.

4. The operation method for a telescopic electric cylinder based on high-precision stroke control according to claim 3, wherein the operation steps of the high-precision stroke control system include:
step S1, the robotic arm grips the object, and the frameless motor controls the extension and retraction of the telescopic electric cylinder through the interaction between the planetary lead screw and the planetary nut for controlling the extension and retraction movement of the robotic arm after grabbing the object, allowing movement of the object;
step S2, the weight unit identifies the weight of the object gripped by the robotic arm, and based on the object's weight, the inertia experienced by the object during movement is measured, wherein the deceleration control module then controls the deceleration of the frameless motor and adjusts the first speed reduction rate during deceleration;
step S3, the height unit identifies the final height to which the object is lifted after being gripped, and based on the object's height, the second speed reduction rate of the frameless motor during deceleration is further controlled. If the distance measuring unit detects a high extension distance of the object, the system proceeds to step S4; otherwise, it moves to step S6;
step S4, after the object's extension distance increases, the planetary lead screw in the telescopic electric cylinder experiences an increased downward force, which causes a tighter fit between the planetary lead screw and the planetary nut, wherein at this point, the deceleration control of the frameless motor is adjusted to the third speed reduction rate;
step S5, the inertia of the object which is moving is influenced by the tightness of the fit between the planetary lead screw and the planetary nut, wherein the inertia data is then adjusted, and the fourth speed reduction rate of the frameless motor during deceleration is calculated;
step S6, afterward, the robotic arm lowers the object and the frameless motor reverses to reset, preparing for the next operation.

5. The operation method for a telescopic electric cylinder based on high-precision stroke control according to claim 4, wherein the first speed deceleration rate in the step S2 is defined as follows:
$$I = \frac{G}{{G}_{max}} * {I}_{max} , {V}_{1} = \frac{{I}_{min}}{I} * {V}_{max} ,$$
wherein G is the weight of the object, wherein Gₘₐₓ is the maximum weight of the object that the robotic arm can handle, wherein I is the inertia of the object during the object movement, wherein Iₘₐₓ is the maximum inertia during the object movement, wherein Iₘᵢₙ is the minimum inertia during the object movement, wherein Vₘₐₓ is the maximum speed reduction rate of the frameless motor, wherein V₁ is the first speed reduction rate of the frameless motor.

6. The operation method for a telescopic electric cylinder based on high-precision stroke control according to claim 5, wherein the second deceleration rate in step S3 is defined as follows:
$${I}_{1} = \frac{H}{{H}_{max}} * {I}_{max} ,$$
wherein H is the height at which the object is located, wherein Hₘₐₓ is the maximum height at which the object can be gripped, wherein I₁ represents the influence of the object's height on inertia;
wherein,
$$I = \frac{G}{{G}_{max}} * {I}_{max} - {I}_{1} ,$$
wherein the higher position of the object, the greater the downward force of the object experiences, which affects the inertia and reduces the inertia of the object during deceleration, wherein the second deceleration rate of the frameless motor is:
$${V}_{2} = {V}_{1} - [ {I}_{min} / ( \frac{G}{{G}_{max}} * {I}_{max} - {I}_{1} ) ] * {V}_{max} .$$

7. The operation method for a telescopic electric cylinder based on high-precision stroke control according to claim 6, wherein the third deceleration rate in step S4 is defined as follows:
when L>L_{mid}, wherein L is the object's extension distance, wherein L_{mid} is the normal extension distance of the object:
$$R = \frac{L}{{L}_{max}} * {R}_{max} ,$$
wherein Lₘₐₓ is the maximum extension distance of the object, R is the fit tightness between the planetary screw and the planetary nut, wherein Rₘₐₓ is the maximum fit tightness between the planetary screw and the planetary nut, wherein the influence of this fit tightness on the deceleration rate of the frameless motor is:
$${V}_{t i g h t} = \frac{{R}_{min}}{R} * V {1}_{max} ,$$
wherein V_{tight} is the influence of the planetary screw and the planetary nut fit tightness on the deceleration rate of the frameless motor, V1ₘₐₓ is the maximum influence between the planetary screw and the planetary nut that can have on the deceleration rate, Rₘᵢₙ is the minimum fit tightness between the planetary screw and the planetary nut;
wherein the third deceleration rate is:
$${V}_{3} = {V}_{1} - [ \frac{{I}_{min}}{( \frac{G}{{G}_{max}} * {I}_{max} - {I}_{1} )} ] * {V}_{max} - {V}_{tight} ;$$
wherein when L≤L_{mid}, then V₃=V₂.

8. The operation method for a telescopic electric cylinder based on high-precision stroke control according to claim 7, wherein the fourth deceleration reset in Step S5 is defined as follows:
$${I}_{2} = \frac{{R}_{min}}{R} * I {2}_{max} , I = \frac{G}{{G}_{max}} * {I}_{max} - {I}_{1} - {I}_{2} ,$$
wherein I₂ is the influence of the tightness between the planetary screw and the planetary nut on the inertia of the object during movement, I2ₘₐₓ is the maximum influence of the tightness between the planetary screw and the planetary nut on movement inertia of the object;
wherein the fourth deceleration rate is then: V
$${V}_{4} = {V}_{1} - [ \frac{{I}_{min}}{( \frac{G}{{G}_{max}} * {I}_{max} - {I}_{1} )} ] * {V}_{max} + [ {I}_{min} / ( \frac{G}{{G}_{max}} * {I}_{max} - {I}_{1} - {I}_{2} ) ] * {V}_{max} ;$$
wherein when L≤L_{mid}, then V₄=V₂.
